(19) United States
(12) Patent Application Publication
(10) Pub. No.: US 2026/0108077 A1
(43) Pub. Date: Apr. 23, 2026

(54) CUSHION FOR A SEATING FURNITURE

(71) Applicant: Inter IKEA Systems B.V., LN DELFT (NL)

(72) Inventors: Sebastian SVENSSON, Killeberg (SE); Jens BENGTSSON, Älmhult (SE)

(73) Assignee: Inter IKEA Systems B.V., LN DELFT (NL)

(21) Appl. No.: 19/117,618

(22) PCT Filed: Oct. 3, 2023
(86) PCT No.: PCT/SE2023/050981

§ 371 Date: Apr. 1, 2025

(30) Foreign Application Priority Data
Oct. 3, 2022 (SE) 2251145-5

(51) Int. Cl. A47C 27/06; A47C 7/02; A47C 7/34; A47C 27/05

(52) U.S. Cl. CPC A47C 27/064; A47C 7/021; A47C 7/34; A47C 27/053; A47C 27/062

(57) ABSTRACT

A cushion (100) for a seating furniture, comprising a plurality of pocket springs (10), wherein a first set (S1) of pocket springs has a first height (H1) that differs from a second height (H2) of a second set (S2) of pocket springs such that a top side (T) of the cushion (100) is non-flat.

WO

### TECHNICAL FIELD

The present invention relates in general to a cushion for a seating furniture as well as to a method for manufacturing such a cushion.

### BACKGROUND

Cushions for seating furniture, such as sofa cushions, are commonly constructed from foam. Foam cushions may be a comfortable alternative short-term, but they can sometimes look and feel saggy after some time in use. Another problem with conventional foam cushions is packaging and transportation. Due to their inflexible composition they cannot be compressed to a large extent, and instead they have to be transported in large packages resulting in a less than efficient use of space in for instance a shipping container. The production set-up for manufacturing of foam cushions often involves tedious manual production steps, and the choice of material for the foam is often limited to unsustainable materials.

Therefore, there is a need for a cushion for a seating furniture which is easier to produce and to transport efficiently while also providing good comfort.

### SUMMARY

An object of the present invention is to solve or at least mitigate the problems related to prior art. This object is achieved by means of the technique set forth in the appended independent claims; preferred embodiments being defined in the related dependent claims.

In an aspect, a cushion for a seating furniture is provided. The cushion comprises a plurality of pocket springs. A first set of pocket springs has a first height that differs from a second height being the height of a second set of pocket springs such that a top side of the cushion is non-flat.

A pocket spring may be defined as a spring enclosed in a pocket. As a consequence of the individually pocket-enclosed springs, the plurality of pocket springs may become relatively individually flexible, so that each spring may flex separately without affecting the neighboring springs. Advantageously, this may increase the users comfort since their weight will be distributed more evenly over the surface receiving the load. The flexibility of the pocket springs further allows for efficient packaging methods, such as roll-packaging, thus the cushion requires much less space during transportation.

In an embodiment, the plurality of pocket springs all have the same diameter. Advantageously, this allows for a cost-efficient manufacturing

The pocket springs may be arranged in rows and columns. This allows for rectangular shape of a bottom side, and linear edges of the cushion. Further, such configuration allows a plurality of pocket springs to be manufactured in strings, which then can be handled and connected to each other instead of assembling separate pocket springs. When all pocket springs have the same diameter and are manufactured in strings, they may all be arranged in rows and columns in a simple processing step, even in the same processing machine. This is much more efficient than attaching the pocket springs in a separate processing step, saving time and cost.

The first height may be higher than the second height, and the first set of pocket springs may be arranged in the center of the cushion such that the top side of the cushion is convex. By this, a higher level of comfort is ensured for the user and the pocket springs are configured to match the design of traditional foam material cushions.

The first set of pocket springs may be arranged towards a front edge of the cushion such that the top side of the cushion is tapered, or sloped. In other words, the cushion may have a higher height towards the front edge, and a lower height towards a rear edge. This facilitates a wider variety of design options for the cushion and provides a direction for the user not to sit on the front edge of the cushion.

The plurality of pocket springs may further comprise a third set of pocket springs having a third height being lower than the first and second heights. By this, a gradual non-flat shape of the top side of the cushion may be achieved.

The third set of pocket springs may be arranged on the opposite side of the second set of pocket springs with regard to the first set of pocket springs.

The plurality of pocket springs may be arranged such that there is a stepwise increase of pocket spring height from an edge of the cushion to the center.

The plurality of pocket springs may be arranged in a first and second layer. The first layer may be arranged under the second layer. The first and second layers may comprise pocket springs having different properties, such as height, width, and/or firmness. The first and second layers may comprise pocket springs arranged differently. As an example, the first layer may exclusively comprise pocket springs having the same height, while the second layer comprises pocket springs having varying heights. The pocket springs of the first and second layer may be arranged in rows and columns corresponding to each other, or overlapping. The first layer may be a stiffer layer, and the second layer may be a softer layer. By the pocket springs being arranged in at least two layers, more design options of the cushion regarding the shape are facilitated.

The plurality of pocket springs may be arranged such that a bottom side of the cushion is flat.

The cushion may further comprise a top layer arranged on top of the plurality of pocket springs. The top layer may comprise a material providing increased stability and/or comfort.

Alternatively or additionally, the cushion may comprise a cover layer arranged around the plurality of pocket springs. The cover layer may be manufactured and transported separately from the pocket spring core, which is beneficial as it facilitates cost-effective and convenient packaging, such as roll-packaging of the pocket spring core, and flat packaging of the cover. The assembly of the cushion may be simply performed by sewing or buttoning. The cushion may alternatively be provided with a zipper, allowing the user to purchase the cover and the pocket spring core separately, and easily assemble the cushion by zipping the cover around the pocket spring core. More design options for the cushion are also facilitated, and the user can easily change the cover while keeping the pocket spring core. After use, the core and the cover may be easily separated and recycled properly. The cover layer may be combined with the top layer for additional comfort and/or stability, or the cover layer may comprise additional material to provide comfort and/or stability on its own.

The top layer and/or cover layer may comprise a comfort material such as foam, wadding, fabric or non-woven textile. Examples of suitable comfort materials includes, but are not limited to: polyester wadding, non-woven polypropylene, polyurethane foam.

In an embodiment, the plurality of pocket springs, the top layer and/or the cover layer comprises a water resistant material. The pocket springs may for instance comprise stainless steel in a synthetic non-woven material such as polypropylene, and the top layer and/or cover layer may comprise polyester fibre wadding. The top layer and/or cover layer may comprise enough water resistant material to provide necessary comfort and/or stability. This is advantageous, as it allows the cushion to be manufactured without any water sensitive material such as metals prone to corrosion, fabric or foam that absorbs water. A cushion manufactured exclusively from water resistant material may be suitable to use for instance in outdoor seating arrangements.

According to a second aspect a furniture, in particular a seating furniture such as a sofa or an armchair, is provided. The furniture comprises a cushion according to the first aspect.

In another aspect, a method for manufacturing a cushion for a seating furniture is provided. The method comprises the step of arranging a plurality of pocket springs in rows and columns. A first set of pocket springs has a first height that differs from a second height being the height of a second set of pocket springs such that a top side of the resulting cushion is non-flat. The method of manufacture is highly flexible and the arrangement of the plurality of pocket springs can be varied in a number of ways to achieve different types of cushion properties. As a result, cushions with different properties can easily be manufactured in small series or the properties can even be specially adapted for each cushion. At the same time the cushion can be manufactured in a relatively uncomplicated and cost-effective manner.

During the step of arranging, the plurality of pocket springs may be arranged such that there is a stepwise increase of pocket spring height from an edge of the cushion to the center.

During the step of arranging, the plurality of pocket springs may be arranged in a first and second layer.

The method may further comprise a step of roll-packing the cushion. Roll-packaging is a highly efficient way to compress cushions for transport, and greatly increases the cost-effectiveness of the logistics involved with manufacturing and distribution of the cushions.

Further objects and advantages of the present invention will be obvious to a person skilled in the art when reading the detailed description below of different embodiments.

### BRIEF DESCRIPTION OF THE DRAWINGS

By way of example, embodiments of the present invention will now be described with reference to the accompanying drawings, in which:

Fig. la is an isometric view of a sofa comprising a sofa cushion according to an embodiment;

FIG. 1b is an isometric view of a cushion according to an embodiment;

FIG. 2 is an isometric view of a cushion according to an embodiment during manufacturing;

FIG. 3a is a side view of a cushion according to an embodiment;

FIG. 3b is a side view of a cushion according to another embodiment;

FIG. 4 is a flowchart showing a method of for manufacturing a cushion according to an embodiment;

FIGS. 5a-5g are different views of different cushions according to various embodiments;

FIGS. 6a-6g are views of different pocket spring configurations for producing cushions according to various embodiments; and

FIG. 7 is an isometric view of a cushion according to an embodiment.

### DETAILED DESCRIPTION OF EMBODIMENTS

In the following, a cushion for a seating furniture will be described, as well as a method for manufacturing a cushion for a seating furniture.

The terms “top” and “bottom” are used to define the normal position of the cushion, i.e. having a top side onto which the person using the cushion is intended to sit upon, and a bottom side forming the underside of the cushion during normal use. Similarly, the term “front” refers to the front edge of the cushion pointing outwards from the seating furniture, and “rear” refers to the rear end of the cushion pointing inwards towards the back of the seating furniture.

As used in this description the expression “longitudinal” refers to the direction of the length of the cushion, i.e. the rear-to-front direction. The expression “transverse” refers to the direction of the width of the cushion. The longitudinal and transverse directions are consequently perpendicular to each other.

The cushion is exemplified as a seat cushion in the following specification, however, the benefits described below is also applicable to other kinds of cushions for seating furniture, such as for instance back cushions.

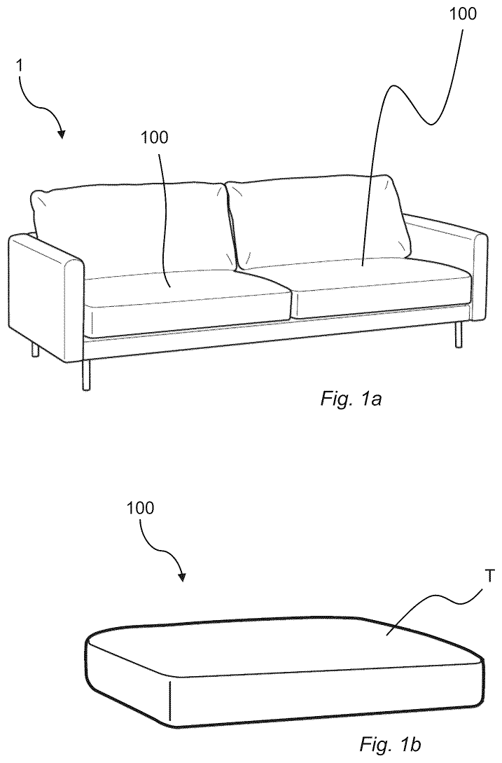

Starting in FIG. 1a a seating furniture 1, here in the form of a sofa, is shown. The sofa 1 comprises a backrest, a seat, legs and armrests. The sofa 1 further comprises sofa cushions 100 in the form of seat cushions on top of the seat and back cushions leaning against the backrest.

The sofa cushion 100 is further shown in FIG. 1b, illustrating the non-planar (or non-flat) configuration of the top side T.

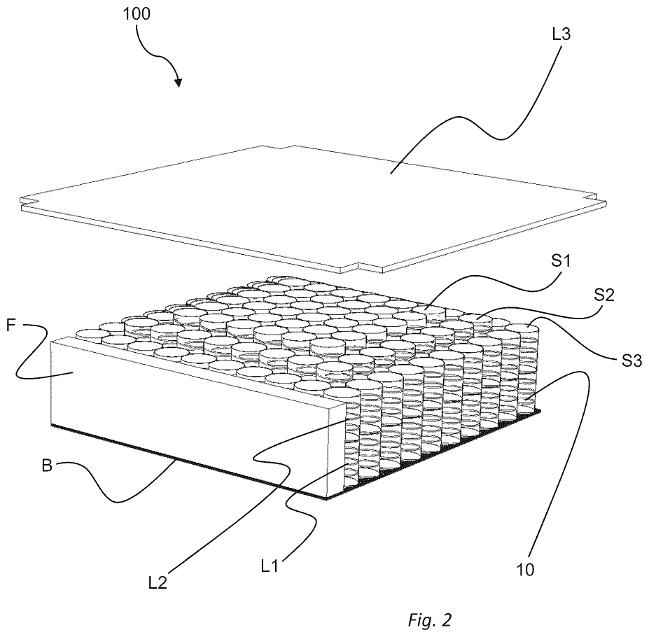

FIG. 2 shows further details of a cushion 100 according to an embodiment. The cushion 100 comprises a plurality of pocket springs 10. A first set S1 of pocket springs has a first height H1 that differs from a second height H2 being the height of a second set S2 of pocket springs such that a top side T of the cushion 100 is non-flat.

Each pocket spring 10 comprises a spring and a fabric material enclosing the spring, preferably on all sides thereof. The fabric material may e.g. be a nonwoven fabric material, a material comprising thermoplastic material or another suitable material. The springs are preferably coil springs, but other spring types are also conceivable. Although shown as cylinder-shaped, the pocket springs 10 may have other configurations such as barrel-shape, hourglass-shape, etc.

The pocket springs 10 are arranged side by side in rows and columns. The rows extends in a transversal direction, and the columns in a longitudinal direction. As shown in FIG. 2, the pocket springs 10 are aligned in both the transverse and longitudinal direction. The pocket springs 10 hence forms a rectangular shape, thereby allowing for linear edges of cushion 100. The pocket springs may alternatively be arranged offset towards each other in the transverse and/or longitudinal direction. In some embodiments the outer rows and/or columns may be made shorter, e.g. by omitting one or more pocket springs 10, such that the cushion 100 exhibits rounded corners.

As shown in FIGS. 1 and 2, the first set S1 of pocket springs are arranged in the center of the cushion 100 and has a higher height H1 than the height H2 of the second set S2 of pocket springs, the second set S2 of pocket springs being arranged outside the first set S1 in a transverse and longitudinal direction. By this, the top side T of the cushion 100 attains a convex shape. A convex shape of a cushion is desirable for many reasons, for instance for increasing the comfort level for the user. Traditionally, cushions for seating furniture are often constructed by a foam material to facilitate such a shape. As mentioned in the background section of the specification foam material has many drawbacks. For instance, the material often needs to be selected from unsustainable materials with poor quality over time. A shape constructed from a foam material may be degenerated over time. In other words, a foam cushion for seating furniture, such as a sofa, may look and feel saggy after some time in use. Another problem with conventional foam based cushions is packaging and transportation. Due to their inflexible composition they can't be compressed very much, and instead have to be transported in large packages, resulting in a less than efficient use of space in for instance a shipping container. The production set-up for manufacturing of foam cushions often involves tedious manual production steps, and the choice of material for the foam is often limited to unsustainable materials. By the cushion 100 of the present inventive concept comprising pocket springs of different heights, the need for foam material is reduced. The solution presented herein provides a less labour intense manufacturing process, since the solution enables a lean and automated production. A further effect of the cushion 100 as disclosed herein, is that the cushion 100 can be packed by vacuum pressing and roll-up for space savings and easier transports. In addition, by having a shape attained by pocket springs 10 of varying heights, better and longer lasting quality of the cushion 100 is ensured.

Although not illustrated, the first set S1 of pocket springs may be arranged towards a front edge of the cushion 100 such that the top side T of the cushion 100 is tapered. This is advantageous for the same reasons as listed above.

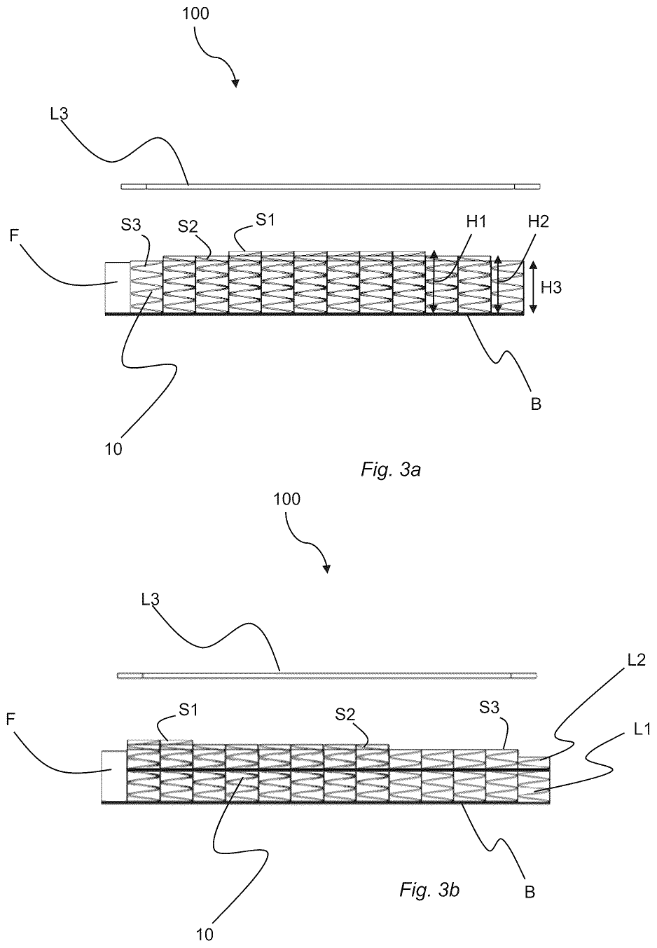

Turning back to FIGS. 2 and 3a-b, a third set S3 of pocket springs has a third height being lower than the first and second heights. The third set S3 of pocket springs are arranged on the opposite side of the second set S2 of pocket springs with regard to the first set S1 of pocket springs. By this, the convex and/or tapered shape may be enhanced, and more design options are facilitated. The plurality of pocket springs 10 are arranged such that there is a stepwise increase of pocket spring height from a front end of the cushion 100 to the center.

In FIG. 2 the the plurality of pocket springs 10 are arranged in a first and second layer L1, L2. It is to be realized that a monolayer, or combinations of several layers of pocket springs, are also feasible to form a cushion 100. By the pocket springs 10 being arranged in at least two layers L1, L2, more design options for the cushion 100 are available as more combinations of pocket springs 10 with varying heights, and especially firmness, are possible. The first layer L1 may for instance comprise pocket springs 10 of a unitary height and an increased firmness, providing a robust base to the cushion 100, and the second layer L2 may comprise pocket springs 10 of varying height and with reduced firmness, providing comfort for the user of the cushion 100.

By this, the softness of the cushion 100 may be easily adjusted during the manufacturing process since the resilience of the springs may be varied for the whole cushion 100 or parts of the cushion 100. Stiffer springs may for instance be arranged in the first layer L1 and/or towards the edges of the cushion 100, and less stiff springs may be arranged in the second layer L2 and/or the center of the cushion 100. Different firmness of different areas of the cushion may also be achieved by a diameter of the spring pockets towards the edges being smaller or greater than the diameter of the spring pockets towards the center of the cushion 100. The plurality of spring pockets may in some embodiments have the same diameter.

In some examples, the plurality of pocket springs 10 are arranged in rows and columns, such that the cushion 100 comprises central pocket springs surrounded by edge pocket springs. The edge pocket springs are preferably arranged along each side of the cushion 100 in one, two, or three rows/columns meaning that each edge is formed by one, two, or three pocket springs in width. However, in some examples the edge pocket springs are only arranged at one or more sides of the cushion.

The central pocket springs are arranged immediately inside of the edge pocket springs. The central pocket springs may form a uniform body of central springs covering the entire space inside the edge pocket springs, or further pocket springs may be arranged inside or close to the central pocket springs. Hence, the central pocket springs may not necessarily be the only pocket springs of the cushion, except for the edge pocket springs. For example, the central pocket springs may be one or more pocket springs arranged inside the edge pocket springs.

Preferably, in some examples the edge pocket springs and the central pocket springs have the same diameter.

The plurality of pocket springs 10 may be arranged such that a bottom side of the cushion 100 is flat.

As illustrated in FIGS. 2 and 3a-b, the cushion 100 further has a top layer L3 arranged on top of the pocket springs 10. The top layer L3 further stabilizes the shape of the cushion 100, while providing additional comfort for the user. Many different materials and dimensions for the top layer L3 may be considered, for instance fabric, foam, nonwoven, or plastic material. The thickness of the top layer L3 may be in the range of 1-25 cm, such as in the range of 3-10 cm. The cushion 100 of FIGS. 2 and 3a-b further comprises front panel F and a bottom layer B. The front panel F may comprise foam, such as for instance polyurethane foam, and/or wadding, such as for instance natural of polyester fiber. The front panel F may comprise any other suitable material for padding, stuffing, or upholstery purposes. The bottom layer B may further stabilize the shape of the cushion 100 and may comprise fabric and/or polymer material. The bottom layer B may be provided with an anti-slip material for better positioning in a sofa 1.

FIG. 3a is showing a cushion 100 according to an embodiment. The cushion 100 has a top profile being similar to the profile of the top side T shown in FIG. 2. However, in FIG. 3a the cushion 100 has a single layer L1 of spring pockets 10. As can be seen in FIG. 3a the cushion 100 has an upper profile that corresponds to the varying height of pocket springs S1, S2, S3. Another example of a cushion 100 is shown in FIG. 3b. The cushion 100 has a tapered top side T due to pocket springs 10 with a higher height being arranged towards the front edge, and pocket springs 10 with a lower height being arranged towards the rear edge. In FIG. 3b, the cushion 100 is provided with two layers L1, L2 of pocket springs 10. Although not illustrated, many more sets of pocket springs 10, or individual pocket springs 10, with different heights are feasible. Each pocket spring 10 may even have a unique height to allow a more continuous variation. The height of the front panel F may be similar to the height of one or two pocket springs 10, or it may be higher/lower to provide more design options. Each row and column may fit between 5 to 20 pocket springs 10 preferably approximately 10 to 12 pocket springs (as shown in FIGS. 2, 3a-b). However, fewer of more pocket springs 10 may be used to decrease or increase the width of the cushion 100 in the transversal and/or longitudinal direction.

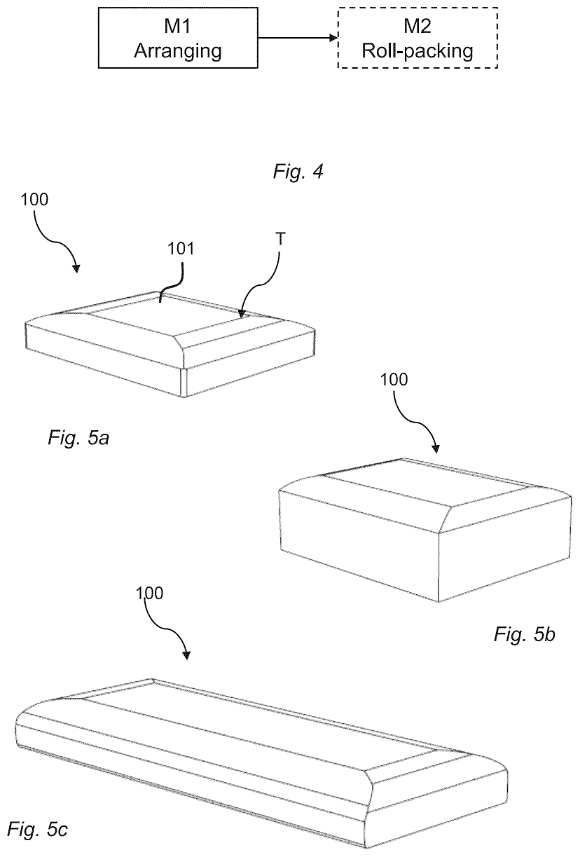

A method for manufacturing a cushion 100 is schematically shown in FIG. 4. The method comprises the step of arranging M1 a plurality of pocket springs 10 in rows and columns. A first set S1 of pocket springs has a first height H1 that differs from a second height H2 being the height of a second set S2 of pocket springs such that a top side T of the resulting cushion 100 is non-flat. The pocket springs 10 may be manufactured according to the following. Each spring is manufactured from a metal wire. Each spring is positioned in a spring pocket made of a fabric material where after the spring pockets are sealed, for instance by means of welding.

The pocket springs 10 may be arranged in a plurality of parallel spring strings. The spring strings may be transverse or longitudinally extending. The spring strings may be attached to each other side by side by means of for instance an adhesive. The method as illustrated in FIG. 4 provides a less labor intense manufacturing process compared to a conventional production set-up for manufacturing of foam cushions, since the present method a lean and automated production. If the cushion 100 comprises double layers L1, L2 of pocket springs, simultaneous manufacturing of the pocket springs for the first and second layer L1, L2 may be performed. The embodiments described in relation to FIGS. 2 and 3a-b may be manufactured by the present method. For instance, during the step of arranging M1, the plurality of pocket springs may be arranged such that there is a stepwise increase of pocket spring height from a front end of the cushion 100 to the center. As illustrated in FIG. 4, the method may further comprise an additional step of roll-packaging M2. In this step M2, the cushion 100 is vacuum packed, rolled up and wrapped such that a very compact and space-reducing packaging is obtained. Once unpacked, the cushion 100 will return to its desired shape.

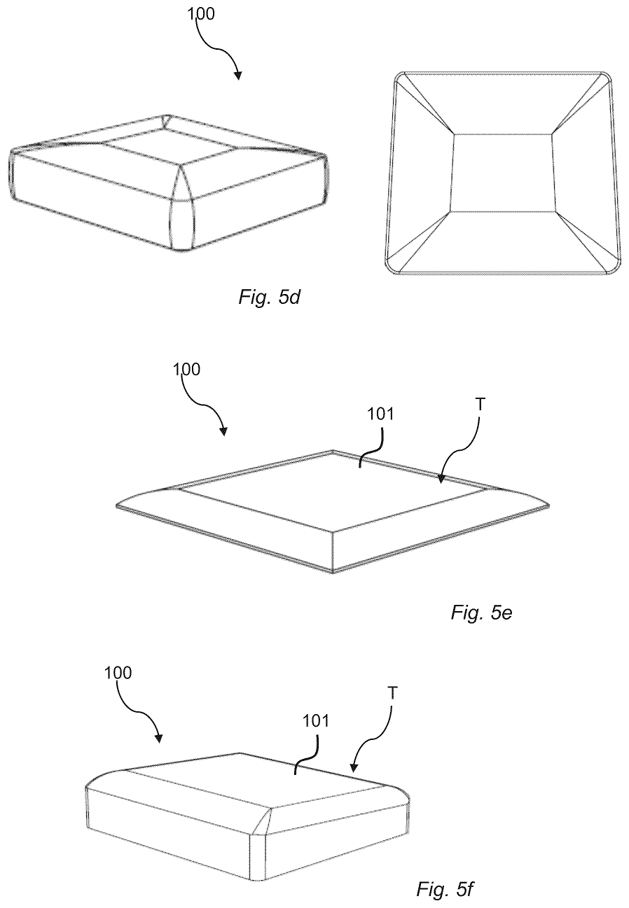

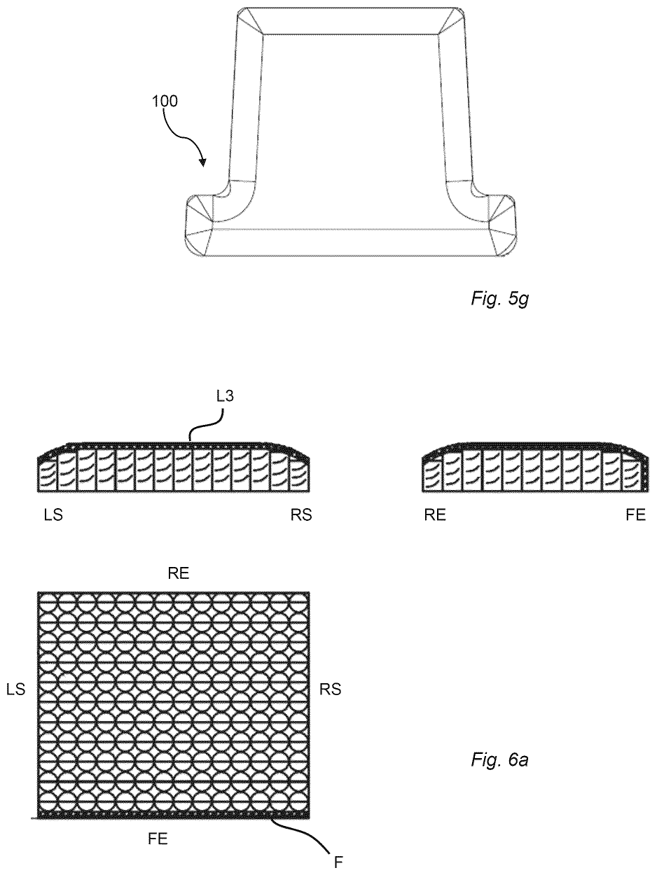

Now turning to FIGS. 5a-g different embodiments of cushions 100 for seating furniture will be briefly described. In FIG. 5a a rectangular cushion 100 is shown, wherein a central portion 101 of the top side T is raised relative all four edges. The central portion 101 tapers towards all four edges, meaning that spring pockets (not shown) are configured and distributed accordingly, i.e. tall spring pockets are arranged at the central portion 101, short spring pockets are arranged at the edges, and intermediate spring pockets (of intermediate height) are arranged in between the short and tall spring pockets.

In FIG. 5b a similar cushion 100 is shown, but here the overall height is increased in comparison with the cushion of FIG. 5a. Optionally, in FIG. 5b the front edge of the cushion 100 may be manufactured by spring pockets of increased robustness, thereby providing extra stability to the front edge and reducing the risk for a user to fall off the cushion 100.

In FIG. 5c a further embodiment of a cushion 100 is shown. The cushion 100 is elongated compared to the cushion of FIG. 5a, and could thus be used for a day bed or for multi-seats sofas with a single cushion.

In FIG. 5d another embodiment of a cushion 100 is shown. The cushion 100 is non-flat in a similar manner as shown in FIG. 5a, but in comparison with the cushion of FIG. 5a, the present cushion 100 of FIG. 5d is tapered in the front-to-rear direction. Hence, the cushion 100 is wider at its front end as compared to its rear end. This is accomplished by reducing the number of spring pockets in the width direction when moving from the front end towards the rear end.

In FIG. 5e a cushion 100 is shown having a significantly reduced overall height. Hence, compared to the cushion of FIG. 5a the present cushion 100 of FIG. 5e is made using significantly shorter pocket springs, although the top side T is still non-flat by increasing the height of the pocket springs towards the central position 101. In a preferred embodiment, the outermost pocket spring of each row/column is shorter than the inner central pocket springs. Hence, the non-flat cushion 100 shown in FIG. 5e is, despite is small height, formed by pocket springs of varying height in order to achieve the non-flat top side T.

The cushion 100 shown in FIG. 5f has no planar central portion, but the top side T is formed by a tilted plane. The central portion 101 tapers towards the edges, but due to the tilted configuration the front edge is taller than the rear edge. The side edges are tilted by the same angle as the central portion 101.

A yet further embodiment of a cushion 100 is shown in FIG. 5g, The cushion 100 has a “T”-shape, making it suitable for an armchair or other similar seating furniture. The front edge has an increased width compared to the central portion and the rear edge. Optionally, the width may decrease in the front-to-rear direction, especially with regards to the central portion and the rear edge. As indicated in FIG. 5g, the edges may be configured to have a height increase in the direction towards the center of the cushion 100.

For the embodiments shown in FIGS. 5a-g, while a layer of foam may be arranged on top of the spring pockets to soften the top side T in order to increase comfort for the user, it should be noted that the non-flat top side T of the cushions 100 is provided due to the different height of the pocket springs.

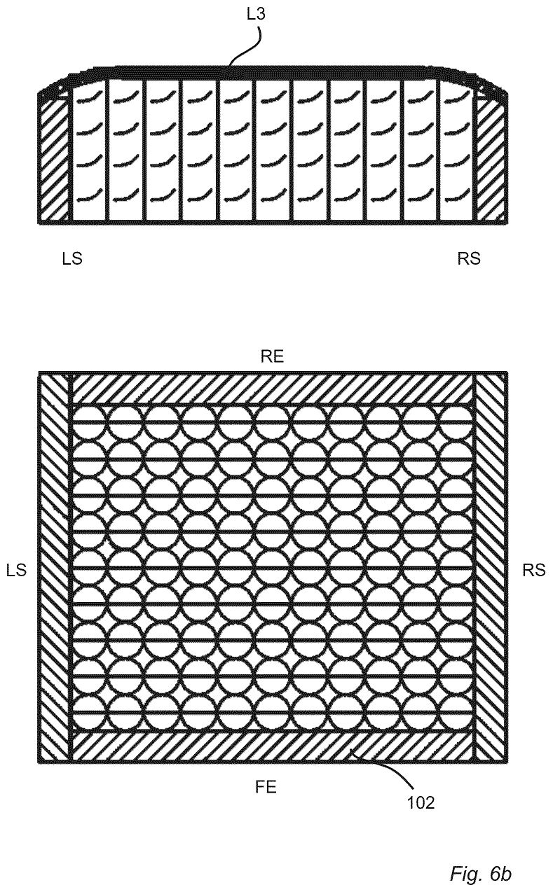

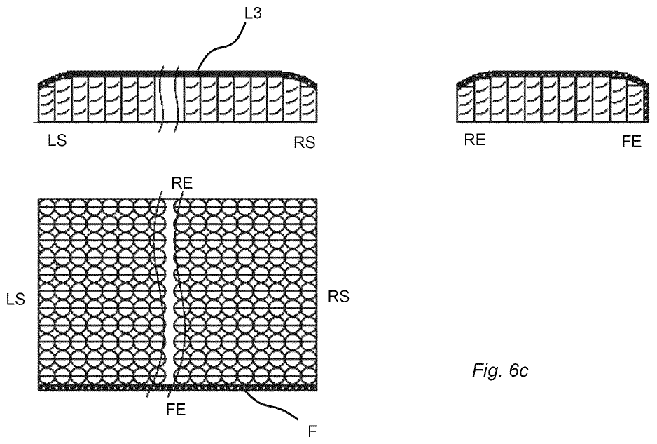

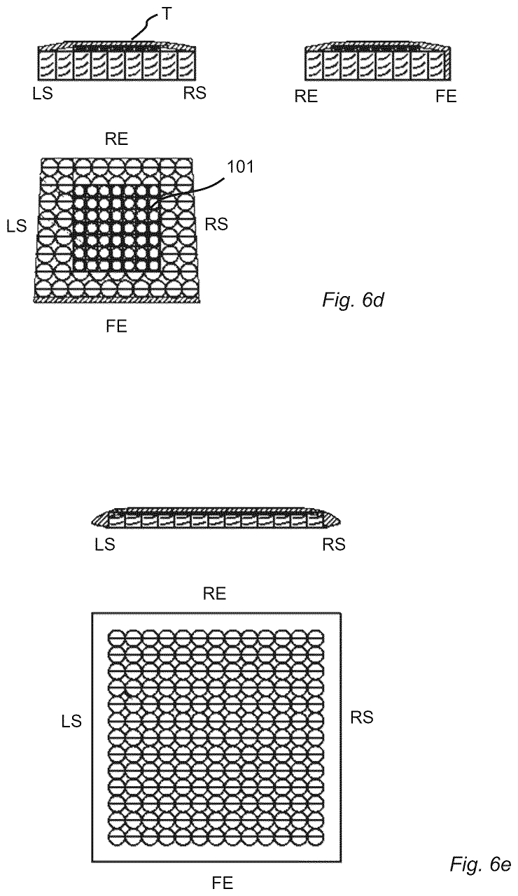

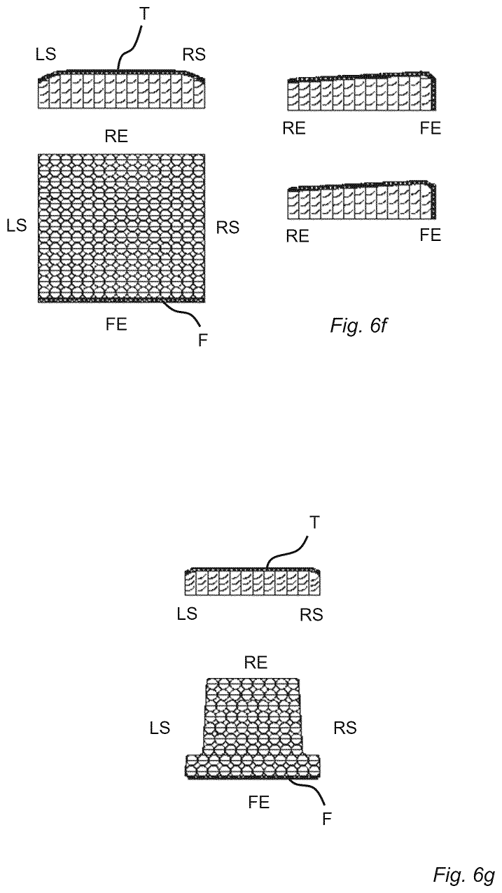

Now turning to FIGS. 6a-g different spring pocket configurations are shown for different embodiments of cushions 100. Throughout the description with regards to these figures, reference numeral FE corresponds to the front edge, RE corresponds to the rear edge, LS corresponds to the left side, and RS corresponds to the right side. Starting in FIG. 6a, the spring pocket configuration is shown for a cushion 100 corresponding to the cushion 100 of FIG. 5a. The spring pockets are arranged in rows and columns, wherein each tapered edge is formed by two rows/columns of spring pockets of decreasing height. The front edge is supported by a front panel F as described above, and a top layer L3 may be provided to improve comfort.

In FIG. 6b another configuration is shown, also indicating a rectangular cushion. The spring pockets are taller, thereby corresponding to the cushion shown in FIG. 5b. Here, a top layer L3 is provided, as well as a rectangular frame 102 covering all sides of the cushion. Further, the outermost spring pockets form a single spring pocket wide tapering.

In FIG. 6c another configuration is shown, indicating the pocket springs used for forming the cushion of FIG. 5c. In the shown example a front panel F is provided, but the spring pockets are considerably shorter than the spring pockets shown in FIG. 6a.

The spring pocket configuration shown in FIG. 6d corresponds to the cushion 100 shown in FIG. 5d. A first layer of spring pockets are forming the tapered shape by having one spring pocket less at the rear edge as compared to the front edge. All spring pockets of the first layer have the same height. The central portion 101 is formed by so called micro spring pockets arranged at a central part of the first layer. The micro spring pockets have a smaller diameter and height, thus forming an elevated area at the top side T.

In FIG. 6e another spring pocket configuration is shown, corresponding to the cushion shown in FIG. 5e. Short spring pockets are used, and a material (such as foam) may surround the spring pockets on all sides (except the bottom side) to form the desired shape. One or more outermost pocket springs of each row and column may be shorter than the inner central pocket springs, such that the top side T of the resulting cushion 100 obtains a convex shape.

In FIG. 6f a spring pocket configuration is shown to form a cushion 100 as shown in FIG. 5f. The height of the spring pockets decrease in the front-to-rear direction, as well as in the side-to-center direction. A front panel F is provided at the front edge, and a top layer 101 is arranged onto the spring pockets.

In FIG. 6g a spring pocket configuration is shown which is used to form the T-shaped cushion 100 shown in FIG. 5g. The front part of the spring pocket configuration comprises two rows of a certain number of spring pockets, and adjacent to the front part a tapered rectangular portion is formed. The front row of the rectangular portion is arranged at the center of the front part, whereby the rectangular portion is tapered in the rearwise direction such that the rear edge RE is formed by a row of spring pockets having a total number of spring pockets being one less than the front row of the rectangular portion. A front panel F is provided as well as a top layer T.

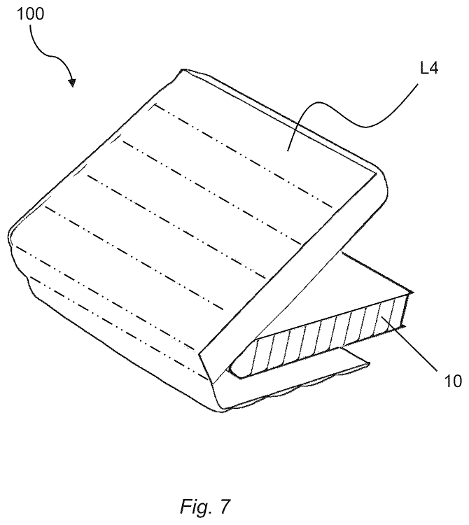

FIG. 7 illustrates a cushion comprising a cover layer L4 enclosing the pocket springs 10. The cover L4 can be manufactured and transported separately, and then zipped, buttoned or sewed around the pocket spring core 10. The cover layer L4 may be thicker on one or more sides to provide additional padding. The cushion may further comprise a top layer L3 between the pocket spring core 10 and the cover layer L4.

It should be mentioned that the inventive concept is by no means limited to the embodiments described herein, and several modifications are feasible without departing from the scope of the appended claims. In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc. do not preclude a plurality. Reference signs in the claims are provided merely as a clarifying example and shall not be construed as limiting the scope of the claims in any way.

1. A cushion for a seating furniture comprising:
a plurality of pocket springs;
wherein a first set of pocket springs has a first height that differs from a second height of a second set of pocket springs such that a top side of the cushion is non-flat.

2. The cushion according to claim 1, wherein the plurality of pocket springs all have the same diameter.

3. The cushion according to claim 1, wherein the pocket springs are arranged in rows and columns.

4. The cushion according to claim 1, wherein the first height is higher than the second height.

5. The cushion according to claim 1, wherein the first set of pocket springs is arranged in the center of the cushion such that the top side of the cushion is convex.

6. The cushion according to claim 1, wherein the first set of pocket springs are arranged towards a front edge of the cushion such that the top side of the cushion is tapered.

7. The cushion according to claim 1, wherein a third set of pocket springs has a third height being lower than the first and the second heights.

8. The cushion according to claim 7, wherein the third set of pocket springs is arranged on the opposite side of the second set of pocket springs with regard to the first set of pocket springs.

9. The cushion according to claim 1, wherein the plurality of pocket springs are arranged such that there is a stepwise increase of pocket spring height from an edge of the cushion to the center.

10. The cushion according to claim 1, wherein the plurality of pocket springs are arranged in a first layer and a second layer.

11. The cushion according to claim 1, wherein the plurality of pocket springs are arranged such that a bottom side of the cushion is flat.

12. The cushion according to claim 1, further comprising a top layer arranged on top of the plurality of pocket springs.

13. The cushion according to claim 1, further comprising a cover layer arranged around the plurality of pocket springs.

14. The cushion according to claim 13, wherein the plurality of pocket springs and/or the cover layer comprises a water-resistant material.

15. A seating furniture comprising at least one cushion according to claim 1.

16. A method for manufacturing a cushion, comprising:
a plurality of pocket springs in rows and columns;
wherein a first set of pocket springs has a first height that differs from a second height of a second set of pocket springs such that a top side of the cushion is non-flat.

17. The method according to claim 16, wherein during the step of arranging, the plurality of pocket springs are arranged such that there is a stepwise increase of pocket spring height from an edge of the cushion to the center.

18. The method according to claim 16, wherein during the arranging, the plurality of pocket springs are arranged in a first layer and a second layer.

19. The method according to claim 16, further comprising roll-packaging the cushion.

20. The cushion according to claim 12, wherein the plurality of pocket springs and/or the top layer comprises a water-resistant material.
